(19) United States
(12) Patent Application Publication
(10) Pub. No.: US 2024/0123961 A1
(43) Pub. Date: Apr. 18, 2024

(54) BRAKE DEVICE, BRAKE SYSTEM, AND VEHICLE

(71) Applicant: HYUNDAI MOBIS Co., Ltd., Seoul (KR)

(72) Inventor: Moo Jin CHOI, Yongin-si (KR)

(73) Assignee: HYUNDAI MOBIS Co., Ltd., Seoul (KR)

(21) Appl. No.: 18/079,595

(22) Filed: Dec. 12, 2022

(30) Foreign Application Priority Data
Oct. 13, 2022 (KR) 10-2022-0131538

(51) Int. Cl. B60T 13/58; B60T 1/06; B60T 13/74; F16D 55/227; F16D 55/228; F16D 65/18

(52) U.S. Cl. CPC B60T 13/58; B60T 1/065; B60T 13/746; F16D 55/227; F16D 55/228; F16D 65/18; F16D 2121/24

(57) ABSTRACT

A brake device comprises a main braking caliper body, a brake pad part including a first brake pad and a second brake pad that are arranged at one side and another side of the main braking caliper body and have first surfaces facing each other, a main braking piston pressurizing second surfaces of the first brake pad and the second brake pad to shorten a distance between the first brake pad and the second brake pad, a parking caliper body coupled to the main braking caliper body and including a locking part caught by the second surface of the first brake pad and a parking piston installed on the parking caliper body and pressuring the second surface of the second brake pad, when the parking piston pressurizes the second brake pad, the locking part of the parking caliper body moves the first brake pad toward the second brake pad.

Pursuant to 35 U.S.C. § 119(a), this application claims the benefit of Korean Patent Application No. 10-2022-0131538, filed on Oct. 13, 2022 in the Korean Intellectual Property Office, which is hereby incorporated by reference as if fully set forth herein.

### TECHNICAL FIELD

The present embodiments relate to a brake device applicable to a vehicle and a vehicle with a brake device installed therein, and more particularly to an opposed brake device implemented integrally with an electronic parking brake and a vehicle with the brake device installed therein.

### BACKGROUND

A brake device mounted in a vehicle is a device for decelerating, stopping, or maintaining a stopped state of a vehicle while driving and is located inside a rotating wheel, and brakes a vehicle by strongly pressing a disc-shaped brake disc rotating together with the wheel using brake pads from both sides.

In a conventional brake device, two brake pads disposed on both sides of a disc are supported to move forward or backward on an accommodation surface of a caliper body fixed to a vehicle. A pad support pin for guiding forward or backward movement of the brake pads, and a spring member for elastically supporting upper parts of two pad plates to prevent vibration of the pad plates and achieving a smooth return operation are installed.

The brake device may be largely divided into a drum-type brake device and a disc-type brake device. The drum-type brake device uses a method of stopping using a shoe in contact with an inner surface of a cylindrical drum, and the disc-type brake device stops the brake pad by contacting a surface of the brake disc rotating together with the wheel. The disc-type brake device has a caliper that is a housing in which the brake pad is located and is coupled to the wheel, and has a simpler structure and a smaller volume than the drum-type brake device and thus is applied to passenger cars. Only one of the two types may be used or the disc-type brake device and the drum-type brake device may be applied the front and to the rear, respectively.

The disc type may be classified into a fixed opposed caliper and a sliding caliper.

The opposed caliper uses a method in which a caliper body is in contact with a brake disc by pressing the brake pad from both sides while being fixed. This method is efficient in that the opposed caliper has a symmetrical structure and has excellent braking force, but in this case, a volume increases because pistons for applying pressure from both sides need to be located on both sides.

The sliding caliper includes a piston pressing only a brake pad at one side and has a structure in which the caliper body slides and brakes by a reaction that pushes the disc. Since the piston is provided on only one side, it is easy to implement the piston and prevents the structure of the caliper from becoming enlarged, and advantageously, there is no need to adjust a speed of the pistons on both sides equally.

In the former case, the brake disc is always fixed at the center of the caliper, but in the latter case, the position of the caliper is slidably coupled on the brake disc.

The vehicle may include a parking brake in addition to the main braking brake. The parking brake is not a brake for braking while driving, but a brake to fix a parked state. In a traditional parking brake, a rear wheel is held with a cable to fix wheels by pulling a lever located on a side of a driver seat. The parking brake has evolved from a hand-operated side lever type to a foot parking brake type operated by foot.

A brake of a passenger vehicle that is recently released is also called an electric parking brake (EPB) as an electronic parking brake. The electronic parking brake may be operated simply with a button, and rotation of the disc is limited by pressing the brake disc using a motor, not a wire.

The electronic parking brake includes one gear and one screw rotated by a motor, and may be installed inside the brake disc. The electronic parking brake uses a parking brake method that is applied to recently released high-end vehicles because the electronic parking brake is conveniently manipulated and uses an auto hold function.

However, in the case of an opposed type brake disc, since the main braking caliper is fixed, the parking brake needs to also be pressed simultaneously from both sides of the brake disc, but it is difficult to place the motor, gear, and piston on both sides of the main braking system, and accordingly, there is a problem that the electronic parking brake needs to be separately provided from the main braking brake.

### SUMMARY

An object of embodiments of the present disclosure provides a brake device including an opposed brake device applied as a main braking brake device and an electronic parking brake applied as a parking brake device, which are integrated into each other.

It will be appreciated by persons skilled in the art that the objects that could be achieved with the present disclosure are not limited to what has been particularly described hereinabove and the above and other objects that the present disclosure could achieve will be more clearly understood from the following detailed description.

Provided is a brake device including a main braking caliper body, a brake pad part including a first brake pad and a second brake pad that are arranged at one side and another side of the main braking caliper body and have first surfaces facing each other, a main braking piston pressurizing second surfaces of the first brake pad and the second brake pad to shorten a distance between the first brake pad and the second brake pad, a parking caliper body coupled to the main braking caliper body and including a locking part caught by the second surface of the first brake pad, and a parking piston installed on the parking caliper body and pressuring the second surface of the second brake pad, wherein, when the parking piston pressurizes the second brake pad, the locking part of the parking caliper body moves the first brake pad toward the second brake pad.

The main braking caliper body may include a first accommodation part that is located in a direction of the second surface of the first brake pad and into which the locking part of the parking caliper body is inserted, and a second accommodation part that is located in a direction of the second surface of the second brake pad and including the parking piston positioned thereon.

The first accommodation part may include a stopper having one side that is opened to expose at least a portion of the first brake pad, and another side limiting a movement range of the parking caliper body.

An upper surface of the main braking caliper body may be opened to expose a top of the brake pad part, and the parking caliper body may include an upper part covering at least a portion of an opened top of the main braking caliper body and connecting the locking part and the parking piston.

The main braking caliper body may include a guide hole extending in a direction parallel to a direction in which the parking piston moves, the parking caliper body may include a guide rod inserted into the guide hole, and the guide rod may slide along the guide hole when the parking piston is driven.

The brake device may further include an assembly bolt coupling the guide rod to the parking caliper body.

The main braking piston may include a first main braking piston pressuring the second surface of the first brake pad, and a second main braking piston pressuring the second surface of the second brake pad, and the first main braking piston and the second main braking piston may operate symmetrically to each other.

When the parking piston is driven, the parking caliper body may move in a direction of the second brake pad with respect to the main braking caliper body.

An extension length of the parking piston when the parking piston is driven may correspond to a sum of a moving distance of the second brake pad and a moving distance of the parking caliper body.

One pair of the second main braking pistons may be provided in a perpendicular direction to a direction in which one pair of the second main braking pistons move, and the parking piston may be located between the pair of second main braking pistons.

The brake device may further include a parking motor located at an upper side of the parking piston and providing driving force to the parking piston, and a pinion gear transmitting force of the parking motor, wherein a rotation axis of the parking motor may be parallel to a direction in which the parking piston is pressurized.

Provided is a brake system including a brake disc, a main braking caliper body into which an end of one side of the brake disc is inserted, a brake pad part including a first brake pad and a second brake pad that are arranged at one side and another side of the main braking caliper body and have first surfaces facing each other, a main braking piston pressurizing second surfaces of the first brake pad and the second brake pad to move the first brake pad and the second brake pad toward the brake disc, a parking caliper body coupled to the main braking caliper body and including a locking part caught by the second surface of the first brake pad, and a parking piston installed on the parking caliper body and pressuring the second surface of the second brake pad, wherein, when the parking piston pressurizes the second brake pad, the locking part of the parking caliper body moves the first brake pad toward the second brake pad.

The main braking piston may include a first main braking piston pressuring the second surface of the first brake pad, and a second main braking piston pressuring the second surface of the second brake pad, the first main braking piston and the second main braking piston may operate symmetrically to each other, and when the parking piston is driven, the parking caliper body may move in a direction of the second brake pad with respect to the main braking caliper body.

Provided is a vehicle including a car body, a rotating wheel located at a lower portion of the car body, a brake disc coupled to the wheel and rotating with the wheel, a main braking caliper body into which an end of one side of the brake disc is inserted, a brake pad part including a first brake pad and a second brake pad that are arranged at one side and another side of the main braking caliper body and have first surfaces facing the brake disc, a main braking piston pressurizing second surfaces of the first brake pad and the second brake pad to move the first brake pad and the second brake pad toward the brake disc, a parking caliper body coupled to the main braking caliper body and including a locking part caught by the second surface of the first brake pad, and a parking piston installed on the parking caliper body and pressuring the second surface of the second brake pad, wherein, when the parking piston pressurizes the second brake pad, the locking part of the parking caliper body moves the first brake pad toward the second brake pad.

The main braking piston may include a first main braking piston pressuring the second surface of the first brake pad, and a second main braking piston pressuring the second surface of the second brake pad, the first main braking piston and the second main braking piston may operate symmetrically to each other, and when the parking piston is driven, the parking caliper body may move in a direction of the second brake pad with respect to the main braking caliper body.

The wheel may include an outer surface facing outward of the vehicle and an inner surface facing inward, the first brake pad may be located on the outer surface of the wheel, and the second brake pad and the parking piston may be located on the inner surface of the wheel.

### BRIEF DESCRIPTION OF THE DRAWINGS

FIG. 1 is a front view of a brake device and a brake disc according to any one of embodiments of the present disclosure.

FIG. 2 is a perspective view of a brake device according to any one of embodiments of the present disclosure.

FIG. 3 is a cross-sectional view taken along A-A of FIG. 2.

FIG. 4 is a perspective view showing a main braking caliper body of a brake device according to any one of embodiments of the present disclosure.

FIG. 5 is an exploded perspective view of the brake device 100 according to any one of embodiments of the present disclosure.

FIG. 6 is a cross-sectional view taken along B-B of FIG. 2.

FIG. 7 is a diagram showing the state in which the parking piston 164 is operated and the brake pad part 120 pressurizes the brake disc 10 in FIG. 6.

### DETAILED DESCRIPTION

Hereinafter, the present disclosure will be described more fully with reference to the accompanying drawings, in which exemplary embodiments of the present disclosure are shown. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art.

Terms used in this disclosure are used to describe specified embodiments and are not intended to limit the scope of another embodiment. The terms of a singular form may include plural forms unless otherwise specified. As used herein, “comprises” and/or “comprising” does not exclude the presence or addition of one or more other components in addition to the stated components. Like reference numerals refer to like elements throughout, and “and/or” includes each and every combination of one or more of the recited elements. Although “first”, “second”, etc. are used to describe various elements, these elements are not limited by these terms, needless to say. These terms are only used to distinguish one component from another. Therefore, needless to say, the first component mentioned below may be the second component within the spirit of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Spatially relative terms “below”, “beneath”, “lower”, “above”, “upper”, etc. may be used to easily describe a correlation between one component and other components. A spatially relative term needs to be understood as a term that includes different directions of components during use or operation in addition to directions shown in the drawings. For example, when a component shown in the drawing is turned over, a component described as “beneath” or “beneath” of another component may be placed “above” of the other component. Accordingly, the exemplary term “below” may include both directions below and above. Components may also be oriented in other orientations, and thus spatially relative terms may be interpreted according to orientation.

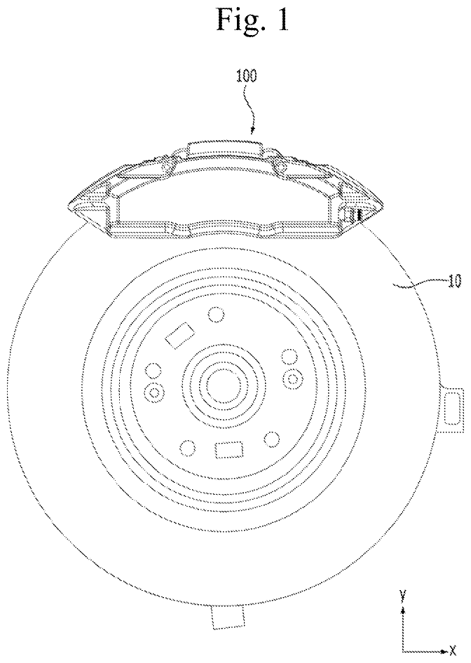

FIG. 1 is a front view of a brake device 100 and a brake disc 10 according to any one of embodiments of the present disclosure. Hereinafter, in describing the brake device 100, a reference of the up-down (y-axis) and left-right (x-axis) directions, and front and rear (z-axis) directions may be based on the brake device 100 illustrated in FIG. 1.

Wheels of the vehicle may be generally disposed on both left and right sides, and a front direction shown in FIG. 1 may be disposed to face the outside of the vehicle. Depending on a type of the brake device 100, front and rear shapes may have a symmetrical shape (opposed caliper brake), or a piston structure may be provided at only one side (sliding caliper brake).

The opposed caliper brake may use a method in which a brake pad part 120 is pressed from both sides to come in contact with the brake disc 10 in the state in which a main braking caliper body 110 is fixed. This method has excellent braking power in terms of a symmetrical structure, but since pistons for pressurization from both sides need to be located on both sides, the volume of an outer part of a wheel may increase and piston speeds on both sides need to be synchronized.

The sliding caliper may include a piston that presses only the brake pad 12 at one side and has a structure in which the main braking caliper body 110 slides and brakes by a reaction that pushes the brake disc with the brake pad at one side.

Since the main braking piston is provided on only one side, it is easy to implement the device, and there is an advantage that it is not necessary to adjust speeds of the pistons at both sides equally. However, braking force is inferior to the opposed caliper brake, and an opposed caliper brake system is introduced for high-end vehicles.

In the opposed caliper brake, the brake disc is always located at the center of the caliper body, but in the slide caliper brake, the position of the caliper body is slidably coupled to the brake disc.

Referring to FIG. 1, the brake device 100 may apply braking to the wheel of the vehicle by pressing a surface of the brake disc 10. The brake disc 10 and a knuckle assembly may be components connected to the wheels of the vehicle.

The brake disc 10 may rotate with rotation of the wheels while the vehicle drives. When the brake device 100 applies pressure to the brake disc 10, resistance may be generated to rotation of the brake disc 10, thereby reducing rotational speed of the wheel. That is, the vehicle may be braked.

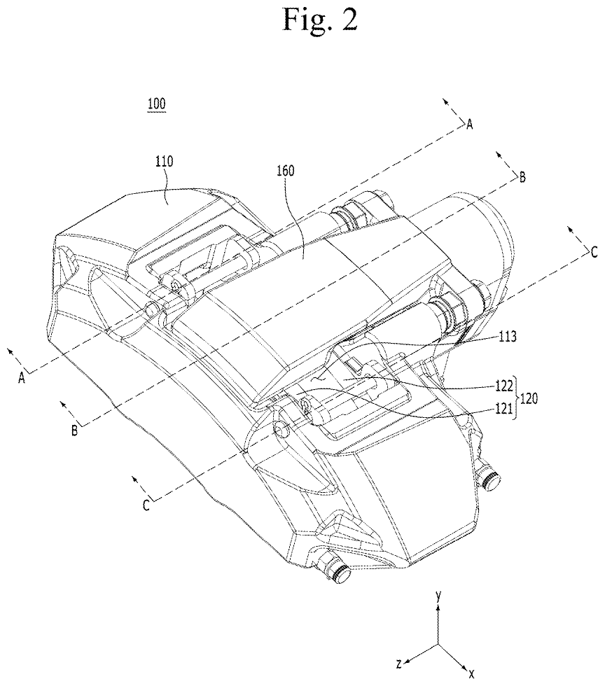

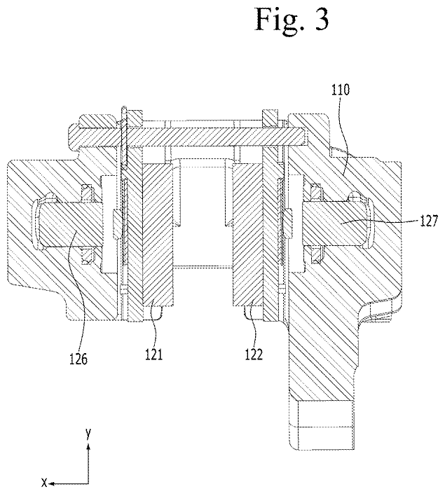

FIG. 2 is a perspective view of the brake device 100 according to any one of embodiments of the present disclosure. FIG. 3 is a cross-sectional view taken along A-A of FIG. 2.

The brake device 100 according to the present disclosure may include the main braking caliper body 110 into which one side of the brake disc 10 is inserted and one pair of brake pads 120 mounted on the main braking caliper body 110 to face both surfaces of the brake disc 10.

The brake disc 10 located in front of the main braking caliper body (facing outward of the vehicle) is referred to as the first brake disc 10 and the brake disc 10 located at the rear is referred to as the second brake disc 10.

The brake device 100 according to the present disclosure may be an opposed caliper brake device 100, in which the brake discs 10 on both sides move simultaneously and are pressed, and the positions of the main braking caliper bodies 110 with respect to the brake disc 10 may correspond to each other in a direction in which the brake pad part 120 moves.

One pair of brake pads 120 may be disposed to allow first surfaces as friction surfaces to face each other, and one side of the brake disc 10 may be inserted into a space 113 between one pair of brake pads 121 and 122.

The opposed caliper brake may be symmetrical left and right and may have the same structure in the inside and the outside of the wheel, but the brake device 100 according to the present disclosure may have an integrated-type parking brake 160 in which only a parking piston 164 is located only at one side.

The parking brake 160 may be a device for fixing the wheel to prevent a vehicle from pushing during parking and may be distinguished from a main braking brake 150 that reduces a rotational speed of the wheel using friction.

The main braking brake 150 may reduce a speed of the wheel using friction, but the parking brake 160 may limit rotation of the wheel using a separate cable or linkage. Conventionally, a mechanical method is mainly used, but recently, an Electronic Parking Brake (EPB) using a motor has been mainly applied to a vehicle.

The conventional parking brake uses a drum type, but recently, the parking brake 160 may also be implemented using the brake disc 10 of the main braking brake 150.

By introducing the electronic parking brake 160, the parking brake 160 may automatically operate when stopped without a separate operation, and a stop and go function that releases the parking brake 160 when starting again may be mounted on the vehicle to enlarge a function of the vehicle.

The electronic parking brake 160 may include the parking piston 164 for pressing the brake disc 10 using a parking motor and a plurality of pinion gears 163 for transmitting power between the parking motor and the parking piston 164.

The parking brake 160 may be separately provided from the main braking brake 150, and a parking caliper body 161 including the parking piston 164 pressurizing the brake disc 10 may be coupled to the brake disc 10 separately from the main braking brake 150. As such, a form in which the main braking brake 150 and the parking brake 160 are provided independently may use a form in which two caliper bodies are coupled to the brake disc 10.

According to the present disclosure, to simplify the configuration and reduce the number of parts, the brake pad part 120 of the main braking brake 150 may also be used for parking, and thus the main braking brake 150 and the parking brake 160 may be integrated into each other.

However, the parking piston 164 and a motor 165 are located on one side (in a rear direction), the parking brake 160 may be applied only to the sliding caliper brake that is to be moved on the brake disc 10.

Although preference for the opposed caliper brake increases due to braking power and appearance, it is difficult to implement a parking brake integrally with the opposite main braking brake, and thus there is a limitation in that two caliper bodies need to be installed separately.

The present disclosure may provide a main braking/parking integrated brake device by adding the slidable parking caliper body 161 to the main braking caliper body 110 to integrally implement the electronic parking brake 160 in the opposed caliper brake system.

As shown in FIG. 3, the main braking brake 150 may include a first main braking piston 126 and a second main braking piston 127 that pressurize one pair of brake pads 121 and 122, respectively. The first main braking piston 126 may be positioned in contact with a second surface of the first brake pad 121 and the second main braking piston 127 may be positioned in contact with a second surface of the second brake pad 122.

The first main braking piston 126 and the second main braking piston 127 may move symmetrically and simultaneously, and simultaneously move the first brake pad 121 and the second brake pad 122 in a direction of the brake disc 10. In this case, the position of the main braking caliper body 110 with respect to the brake disc 10 may not change.

A pair of the first main braking piston 126 and the second main braking piston 127 may each be provided in a horizontal direction (y-axis direction) to uniformly apply a force to a long brake pad in a horizontal direction to increase braking force. Therefore. FIG. 3 may also be a cross-sectional view taken along C-C of FIG. 2.

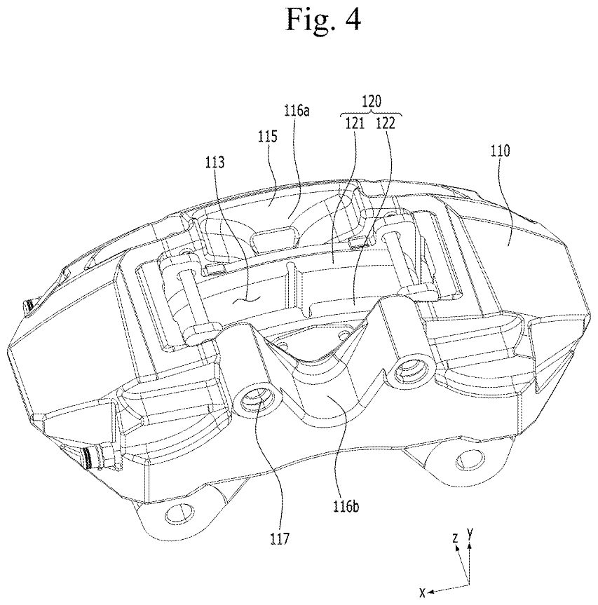

FIG. 4 is a perspective view showing the main braking caliper body 110 from which the parking caliper body 161 of the brake device 100 is separated according to any one of embodiments of the present disclosure. A general opposed caliper body may have a closed top, but the main braking caliper body 110 according to the present disclosure may be opened at the top to connect the parking caliper body 161.

The main braking caliper body 110 may include a first caliper body positioned at the front and a second caliper body positioned at the rear, and the brake pad part 120 may be disposed in the internal space 113 formed between the first caliper body and the second caliper body. A lower portion of the inner space of the main braking caliper body 110 may be opened to insert the brake disc 10 thereinto, and an upper portion may be opened to couple the parking brake 160 thereto as described above.

An accommodation part 116 may be formed in the main braking caliper body 110 to accommodate the parking caliper body 161 thereon, and may include a first accommodation part 116a formed in the first caliper body and a second accommodation part 116b formed in the second caliper body. In both the first accommodation part 116a and the second accommodation part 116b, an upper surface part is open, and the second surface of the brake pad part 120 may be partially exposed.

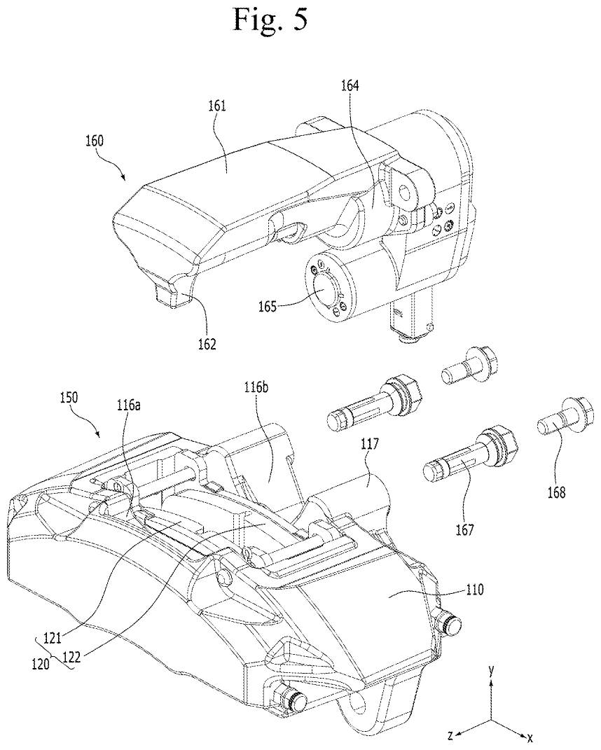

FIG. 5 is an exploded perspective view of the brake device 100 according to any one of embodiments of the present disclosure. The parking caliper body 161 may be located on an upper surface of the main braking caliper body 110 and may extend in forward and backward directions.

The motor 165 and the parking piston 164 may be located in a rear direction of the main braking caliper body 110, the parking piston 164 may be located on the second accommodation part 116b formed in the second caliper body, and the motor 165 may be located at the rear of the main braking caliper body 110.

The parking piston 164 may be located at the center of the horizontal direction (y-axis direction) of the brake pad part 120, and may be located at the center of one pair of the second main braking pistons 127 arranged in a horizontal direction.

Since the parking caliper body 161 is coupled to an upper side of the main braking caliper body 110, the parking piston 164 may be positioned slightly above the second main braking pistons 127.

The front of the parking caliper body 161 may include a locking part 162 in contact with the second surface of the first brake pad 121, and may be inserted into the first accommodation part 116a formed in the first body.

The parking caliper body 161 may be slidably coupled to the main braking caliper body 110. The parking caliper body 161 may be coupled to the main braking caliper body 110 through a guide rod 167 inserted into a guide hole 117 formed in the main braking caliper body 110 in such a way that the parking piston 164 moves in a direction in which the parking piston 164 moves, that is, in a direction in which the brake pad part 120 moves.

The guide hole 117 may extend in forward and backward directions of the main braking caliper body 110, that is, parallel to a direction in which the parking piston 164 moves, and the guide rod 167 may slide within the guide hole 117.

When the guide rod 167 is integrally configured with the parking caliper body 161, it may be difficult to couple the parking caliper body 161 to the main braking caliper body 110, and thus after the guide rod 167 is inserted into the guide hole 117, the locking part 162 and the parking piston 164 of the parking caliper body 161 may be coupled to the accommodation part 116 to be accommodated thereon.

Then, the guide rod 167 and the parking caliper body 161 may be coupled to each other through an assembly bolt 168 to assemble the guide rod 167 and the parking caliper body 161. The parking caliper body 161 may be coupled to the main braking caliper body 110 to allow movement in the z-axis direction (forward and backward movement) and limit movement in other directions.

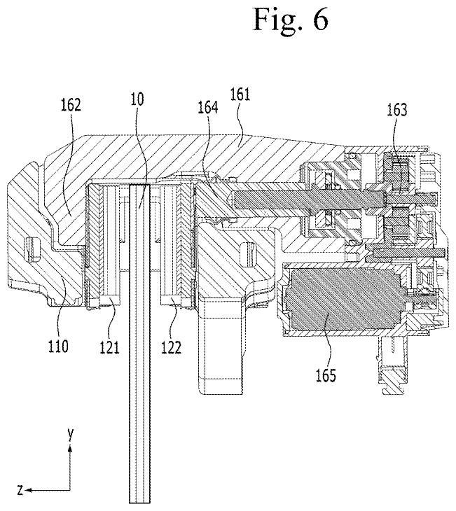

FIG. 6 is a cross-sectional view taken along B-B of FIG. 2, and as seen from FIG. 6, the parking brake 160 is coupled to the main braking brake 150. The second accommodation part 116b may be opened in forward and backward directions, the second surface of the second brake pad 122 may be exposed at the front, and a shaft of the parking piston 164 may extend at the rear.

Since the parking motor 165 and the parking piston 164 are vertically disposed in parallel, a plurality of pinion gears for transmitting rotational force of the parking motor 165 may be disposed.

The parking piston 164 may include a piston shaft that rotates by receiving the rotational force of the motor 165 and a cylinder that moves linearly in an extension direction of the piston shaft when the piston shaft rotates.

The parking piston 164 may be in contact with the second surface of the second brake pad 122, and the locking part 162 of the parking caliper body 161 may be in contact with the second surface of the first brake pad 121. An upper portion connecting the locking part 162 and the parking piston 164 may extend forward and backward across the top of the pair of brake pads 120.

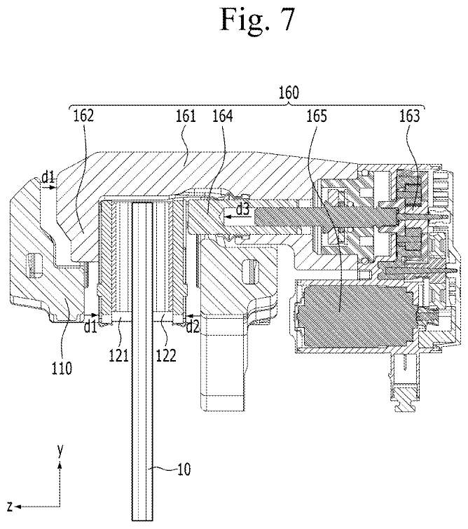

FIG. 7 is a diagram showing the state in which the parking piston 164 is operated and the brake pad part 120 pressurizes the brake disc 10 in FIG. 6.

The parking piston 164 may have a longer length and apply a force in the z-axis direction, that is, in a forward direction, and press and move the second brake pad 122 in the direction of the brake disc 10. In this case, when the second brake pad 122 comes into contact with the brake disc 10, the parking caliper body 161 may move in a rear direction, and the first brake pad 121 may move in a direction of the brake disc 10.

The second brake pad 122 and the first brake pad 121 may move simultaneously or the first brake pad 121 may move after the second brake pad 122 moves as described above.

When the parking piston 164 extends, the first brake pad 121 may be pressurized by pushing the parking caliper body 161 in an opposite direction to the direction in which the parking piston 164 extends (action and reaction) while pressuring the second brake pad 122.

An extension length d3 of the parking piston 164 may correspond to the sum of a moving distance d1 of the first brake pad 121 and a moving distance d2 of the second brake pad 122 and a moving distance of the first brake pad 121 may be equal to a moving distance of a parking caliper.

The main braking caliper body 110 may be an opposed caliper brake and may always in the same position relative to the brake disc 10 in the z-axis direction (forward and backward directions), but the parking caliper body 161 may have a different relative position with respect to the main braking caliper body 110 and the brake disc 10 to press the brake pad part 120 while parking.

An operation of the parking caliper body 161 may use a slide caliper method, and the brake device 100 according to the present disclosure may increase braking performance using an opposed caliper method, and simultaneously, may implement an Electronic Parking Brake (EPB) driven using the slide caliper method using one brake pad part 120.

The parking caliper body 161 may be slidable using the main braking caliper body 110 as a torque member of the parking caliper body 161, and there may be an advantage in that the main braking brake 150 and the parking brake 160 are easily assembled and disassembled integrally.

According to any one of embodiments of the present disclosure, an operation of the parking caliper body may use a slide caliper method, and the brake device according to the present disclosure may increase braking performance using an opposed caliper method, and simultaneously, may implement an Electronic Parking Brake (EPB) driven using the slide caliper method using one brake pad.

The parking caliper body may be slidable using the main braking caliper body as a torque member of the parking caliper body, and there may be an advantage in that the main braking brake and the parking brake are easily assembled and disassembled integrally.

It will be appreciated by persons skilled in the art that the effects that could be achieved with the present disclosure are not limited to what has been particularly described hereinabove and other advantages of the present disclosure will be more clearly understood from the above detailed description.

The detailed description of the exemplary embodiments of the present disclosure disclosed as described above is provided to enable those skilled in the art to make and practice the present disclosure. Although the above has been described with reference to exemplary embodiments of the present disclosure, it will be understood by those skilled in the art that various modifications and changes are made to the present disclosure without departing from the scope of the present disclosure.

What is claimed is:

1. A brake device comprising:
a main braking caliper body;
a brake pad part including a first brake pad and a second brake pad that are arranged at one side and another side of the main braking caliper body and have first surfaces facing each other;
a main braking piston pressurizing second surfaces of the first brake pad and the second brake pad to shorten a distance between the first brake pad and the second brake pad;
a parking caliper body coupled to the main braking caliper body and including a locking part caught by the second surface of the first brake pad; and
a parking piston installed on the parking caliper body and pressuring the second surface of the second brake pad,
wherein, when the parking piston pressurizes the second brake pad, the locking part of the parking caliper body moves the first brake pad toward the second brake pad.

2. The brake device of claim 1, wherein the main braking caliper body includes:
a first accommodation part that is located in a direction of the second surface of the first brake pad and into which the locking part of the parking caliper body is inserted; and
a second accommodation part that is located in a direction of the second surface of the second brake pad and including the parking piston positioned thereon.

3. The brake device of claim 2, wherein the first accommodation part includes a stopper having one side that is opened to expose at least a portion of the first brake pad, and another side limiting a movement range of the parking caliper body.

4. The brake device of claim 2, wherein an upper surface of the main braking caliper body is opened to expose a top of the brake pad part, and
wherein the parking caliper body includes an upper portion covering at least a portion of an opened top of the main braking caliper body and connecting the locking part and the parking piston.

5. The brake device of claim 1, wherein the main braking caliper body includes a guide hole extending in a direction parallel to a direction in which the parking piston moves,
wherein the parking caliper body includes a guide rod inserted into the guide hole, and
wherein the guide rod slides along the guide hole when the parking piston is driven.

6. The brake device of claim 5, further comprising:
an assembly bolt coupling the guide rod to the parking caliper body.

7. The brake device of claim 1, wherein the main braking piston includes a first main braking piston pressuring the second surface of the first brake pad, and a second main braking piston pressuring the second surface of the second brake pad, and
wherein the first main braking piston and the second main braking piston operate symmetrically to each other.

8. The brake device of claim 7, wherein, when the parking piston is driven, the parking caliper body moves in a direction of the second brake pad with respect to the main braking caliper body.

9. The brake device of claim 8, wherein when the parking piston is driven, an extension length of the parking piston corresponds to a sum of a moving distance of the second brake pad and a moving distance of the parking caliper body.

10. The brake device of claim 7, wherein a pair of the second main braking pistons are provided in a perpendicular direction to a direction in which the pair of the second main braking pistons move, and
wherein the parking piston is located between the pair of second main braking pistons.

11. The brake device of claim 1, further comprising:
a parking motor located at an upper side of the parking piston and providing driving force to the parking piston; and
a pinion gear transmitting force of the parking motor,
wherein a rotation axis of the parking motor is parallel to a direction in which the parking piston is pressurized.

12. A brake system comprising:
a brake disc;
a main braking caliper body into which an end of one side of the brake disc is inserted;
a brake pad part including a first brake pad and a second brake pad that are arranged at one side and another side of the main braking caliper body and have first surfaces facing each other;
a main braking piston pressurizing second surfaces of the first brake pad and the second brake pad to move the first brake pad and the second brake pad toward the brake disc;
a parking caliper body coupled to the main braking caliper body and including a locking part caught by the second surface of the first brake pad; and
a parking piston installed on the parking caliper body and pressuring the second surface of the second brake pad,
wherein, when the parking piston pressurizes the second brake pad, the locking part of the parking caliper body moves the first brake pad toward the second brake pad.

13. The brake system of claim 12, wherein the main braking piston includes a first main braking piston pressuring the second surface of the first brake pad, and a second main braking piston pressuring the second surface of the second brake pad,
wherein the first main braking piston and the second main braking piston operate symmetrically to each other, and
wherein, when the parking piston is driven, the parking caliper body moves in a direction of the second brake pad with respect to the main braking caliper body.

14. A vehicle comprising:
a car body;
a rotating wheel located at a lower portion of the car body;
a brake disc coupled to the rotating wheel and rotating with the rotating wheel;
a main braking caliper body into which an end of one side of the brake disc is inserted;
a brake pad part including a first brake pad and a second brake pad that are arranged at one side and another side of the main braking caliper body and have first surfaces facing the brake disc inserted into the main braking caliper body;
a main braking piston pressurizing second surfaces of the first brake pad and the second brake pad to move the first brake pad and the second brake pad toward the brake disc;
a parking caliper body coupled to the main braking caliper body and including a locking part caught by the second surface of the first brake pad; and
a parking piston installed on the parking caliper body and pressuring the second surface of the second brake pad,
wherein, when the parking piston pressurizes the second brake pad, the locking part of the parking caliper body moves the first brake pad toward the second brake pad.

15. The vehicle of claim 14, wherein the main braking piston includes a first main braking piston pressuring the second surface of the first brake pad, and a second main braking piston pressuring the second surface of the second brake pad,
wherein the first main braking piston and the second main braking piston operate symmetrically to each other, and
wherein, when the parking piston is driven, the parking caliper body moves in a direction of the second brake pad with respect to the main braking caliper body.

16. The vehicle of claim 14, wherein the rotating wheel includes an outer surface facing outward of the vehicle and an inner surface facing inward,
wherein the first brake pad is located on the outer surface of the rotating wheel, and
wherein the second brake pad and the parking piston are located on the inner surface of the rotating wheel.
